(19) United States
(12) Patent Application Publication
(10) Pub. No.: US 2014/0362509 A1
(43) Pub. Date: Dec. 11, 2014

(54) ELECTRONIC DEVICE WITH DETACHABLE TABLET COMPUTER

(71) Applicant: HON HAI PRECISION INDUSTRY CO., LTD., New Taipei (TW)

(72) Inventor: CHIA-HUEI LIN, New Taipei (TW)

(73) Assignee: HON HAI PRECISION INDUSTRY CO., LTD., New Taipei (TW)

(21) Appl. No.: 14/187,341

(22) Filed: Feb. 24, 2014

(30) Foreign Application Priority Data
Jun. 5, 2013 (TW) 102119856

(51) Int. Cl. G06F 1/16

(52) U.S. Cl. CPC G06F 1/1669
USPC 361/679.12

(57) ABSTRACT

An electronic device includes a chassis and a tablet computer. The chassis includes a keyboard module and a chassis connector. The chassis connector includes a first group of pins and a second group of pins. The first group of pins and the second group of pins are same. A tablet computer includes a display and a tablet computer connector. The tablet computer connector includes a first group of slots. The tablet computer is configured to be mounted to the chassis and be electronically connected to the keyboard module in a first position and a second position. In the first position, the first group of slots mates with the first group of pins. In the second position, the first group of slots mates with the second group of pins.

### FIELD

The present disclosure relates to electronic devices, and more particularly to an electronic device with a detachable tablet computer.

### BACKGROUND

Many laptop computers have hinges that allow displays to rotate 360 degrees relative to a base. However, when the display rotates relative to the base more than 180-degrees, a keyboard on the base and the display are back-to-back making it difficult to use the keyboard when watching the display. Some laptop computers employ a horizontally rotatable hinge to rotate the display. However, it is cost inefficient and not durable.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an isometric, exploded view of an embodiment of an electronic device.

FIG. 2 is a bottom view of a chassis connector of the electronic device in FIG. 1.

FIG. 3 is a top view of a tablet computer connector of the electronic device in FIG. 1.

FIG. 4 is an assembled view of the electronic device of FIG. 1, with a tablet computer covered on a chassis.

FIG. 5 is similar to FIG. 4, but the tablet computer is angled relative to the chassis.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

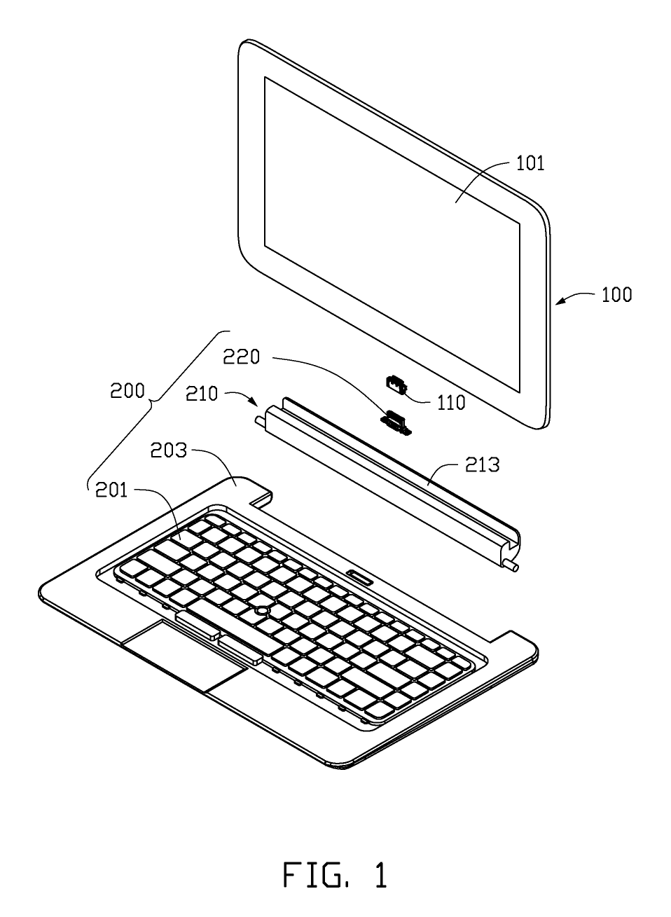

FIG. 1 illustrates an embodiment of an electronic device. The electronic device includes a chassis 200 and a tablet computer 100. The tablet computer 100 is detachable from the chassis 200.

The tablet computer 100 includes a display 101 and a tablet computer connector 110.

The chassis 200 includes a body 203, a keyboard module 201, a pivot member 210, and a chassis connector 220. The keyboard module 201 is mounted to the body 203. The pivot member 210 is mounted to a side of the body 203 and is rotatable relative to the body 203. The pivot member 210 defines a groove 213 receiving the tablet computer 100. The chassis connector 220 is positioned in the groove 213 and is electronically connected to the keyboard module 201.

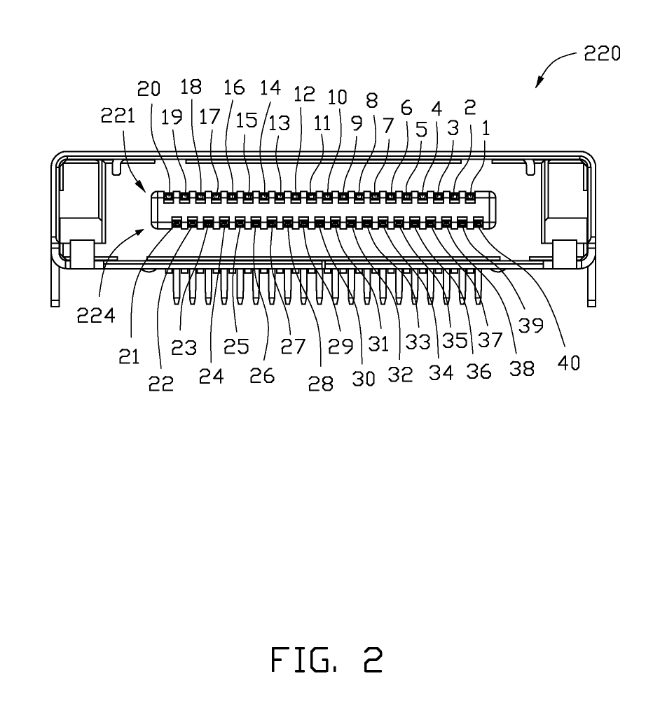

FIG. 2 illustrates a bottom view of the chassis connector 220. The chassis connector 220 includes a first group of pins 221 and a second group of pins 224. The first group of pins 221 and the second group of pins 224 are same. In one embodiment, the first group of pins 221 includes 20 pins labeled from 1 to 20, and the second group of pins 224 includes 20 pins labeled from 21 to 40. The pins of the first group of pins 221 correspond to the pins of the second group of pins 224. An alignment of the first group of pins 221 and an alignment of the second group of pins 224 are centrally symmetrical. The alignment of the first group of pins 221 is substantially straight. The alignment of the second group of pins 224 is substantially straight. The alignment of the first group of pins 221 is substantially parallel to the alignment of the second group of pins 224. An alignment direction of the first group of pins 221 is opposite to an alignment direction of the second group of pins 224.

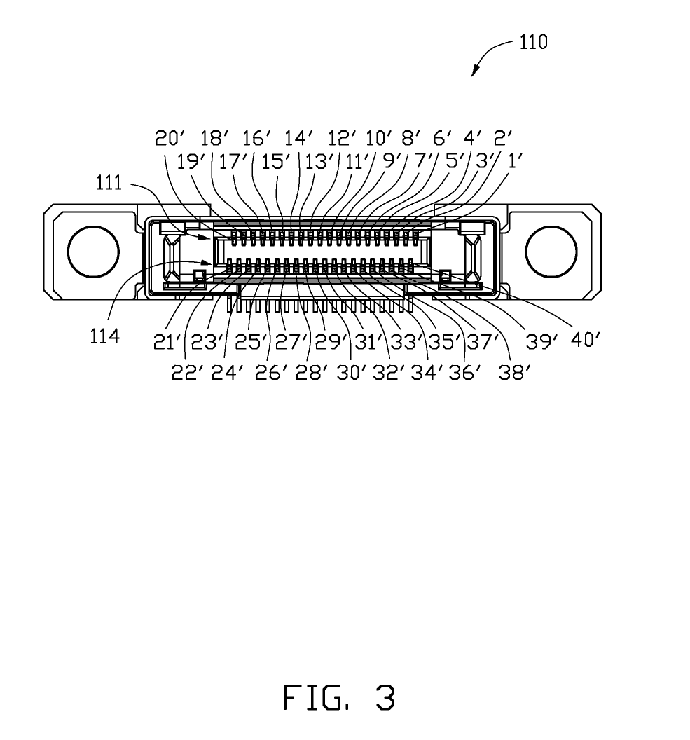

FIG. 3 illustrates a top view of the tablet computer connector 111. The tablet computer connector 114 includes a first group of slots 111 and a second group of slots 114. The first group of slots 111 and the second group of slots 114 are same. In one embodiment, the first group of slots 111 includes 20 slots labeled from 1′ to 20′, and the second group of slots 114 includes 20 slots labeled from 21′ to 40′. The slots of the first group of slots 111 correspond to the slots of the second group of slots 114. An alignment of the first group of slots 111 and an alignment of the second group of slots 114 are centrally symmetrical. The alignment of the first group of slots 111 is substantially straight. The alignment of the second group of slots 114 is substantially straight. The alignment of the first group of slots 111 is substantially parallel to the alignment of the second group of slots 114. An alignment direction of the first group of slots 111 is opposite to an alignment direction of the second group of slots 114.

In assembly, the keyboard module 201 is mounted to the body 203. The rotating member 210 is rotatably mounted to the body 203. An extending direction of the groove 213 of the rotating member 210 is substantially parallel to a plane defined by the keyboard module 201.

The tablet computer 100 can be mounted to the rotating member 210 in either a first position or a second position. In the first position, the tablet computer connector 110 is plugged to the chassis connector 220. The tablet computer 100 is mounted to the chassis 200 and is under control of the keyboard module 201. The first group of slots 111 mates with the first group of pins 221, the second group of slots 114 mates with the second group of pins 224, and the tablet computer 100 is in a first orientation relative to the chassis 200. In the second position, the tablet computer connector 110 is plugged into the chassis connector 220 in a different manner in the first position. The tablet computer 100 is mounted to the chassis 200 and is also under control of the keyboard module 201. However, the first group of slots 111 mates with the second group of pins 224, the second group of slots 114 mates with the first group of pins 221, and the tablet computer 100 is in a second orientation relative to the chassis 200. The first orientation is opposite to the second orientation.

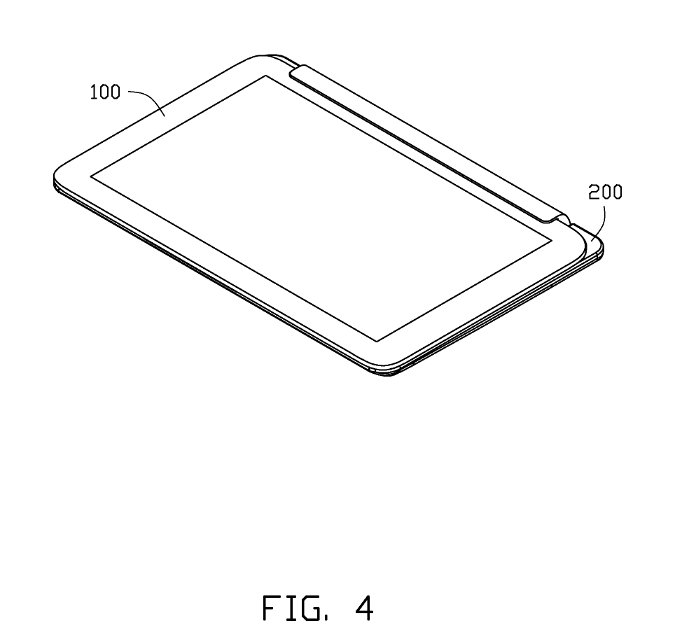

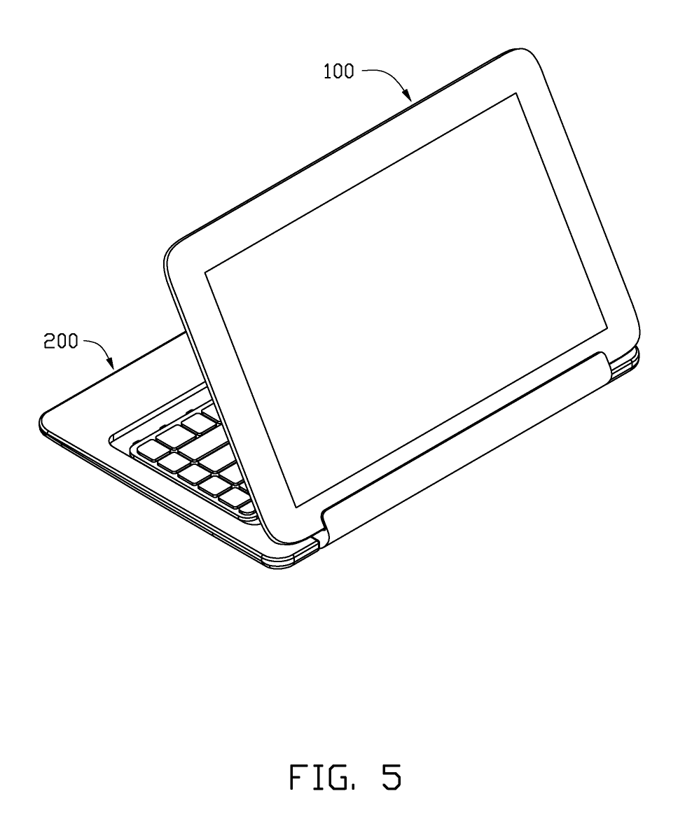

FIGS. 4 and 5 illustrate two working states of the electronic device. The tablet computer 100 can cover the chassis 200 leaving the display 101 outward. The chassis 200 can also be a stand supporting the angled tablet computer 100.

In one embodiment, only one group of the first group of pins 221 and the second group of pins 224 can be used to couple to the first group of slots 111 and the second group of slots 114.

In another embodiment, only one group of the first group of slots 111 and the second group of slots 114 can be used to be couple to the first group of pins 221 and the second group of pins 224.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a chassis comprising a keyboard module and a chassis connector electronically connected to the keyboard module, the chassis connector comprising a first group of pins and a second group of pins, the first group of pins and the second group of pins being similar; and
a tablet computer comprising a display and a tablet computer connector connected to the display, the tablet computer connector comprising a first group of slots;
wherein the tablet computer is configured to be mounted to the chassis and electronically connected to the keyboard module in a first position and a second position; when the tablet computer is in the first position, the first group of slots mates with the first group of pins; and when the tablet computer is in the second position, the first group of slots mates with the second group of pins.

2. The electronic device of claim 1, wherein an alignment of the first group of pins and an alignment of the second group of pins are centrally symmetrical.

3. The electronic device of claim 1, wherein an alignment of the first group of pins is substantially straight, an alignment of the second group of pins is substantially straight, and the alignment of the first group of pins is substantially parallel to the alignment of the second group of pins.

4. The electronic device of claim 3, wherein an alignment direction of the first group of pins is opposite to an alignment direction of the second group of pins.

5. The electronic device of claim 1, wherein the chassis further comprises a body and a pivot member rotatable relative to the body, the pivot member defines a groove to receive the tablet computer, and the chassis connector is located in the groove.

6. The electronic device of claim 4, wherein the keyboard module is located on the body, and an extending direction of the groove is substantially parallel to a plane defined by the keyboard module.

7. The electronic device of claim 1, wherein the tablet computer connector further comprises a second group of slots, when the tablet computer is in the first position, the second group of slots mates with the second group of pins; and when the tablet computer is in the second position, the second group of slots mates with the first group of pins.

8. The electronic device of claim 7, wherein the first group of slots and the second group of slots are similar.

9. The electronic device of claim 1, wherein when the tablet computer is in the first position, the tablet computer is in a first orientation relative to the chassis, when the tablet computer is in the second position, the tablet computer is in a second orientation relative to the chassis, and the first orientation is opposite to the second orientation.

10. An electronic device comprising:
a chassis comprising a keyboard module and a chassis connector electronically connected to the keyboard module, the chassis connector comprising a first group of pins; and
a tablet computer comprising a display and a tablet computer connector connected to the display, the tablet computer connector comprising a first group of slots and a second group of slots, the first group of slots and the second group of slots are similar;
wherein the tablet computer is configured to be mounted to the chassis and electronically connected o the keyboard module in a first position and a second position, when the tablet computer is in the first position, the first group of pins mates with the first group of slots; and when the tablet computer is in the second position, the first group of pins mates with the second group of slots.

11. The electronic device of claim 10, wherein an alignment of the first group of slots and an alignment of the second group of slots are centrally symmetrical.

12. The electronic device of claim 10, wherein an alignment of the first group of slots is substantially straight, an alignment of the second group of slots is substantially straight, and the alignment of the first group of slots is substantially parallel to the alignment of the second group of slots.

13. The electronic device of claim 12, wherein an alignment direction of the first group of slots is opposite to an alignment direction of the second group of slots.

14. The electronic device of claim 10, wherein the chassis further comprises a body and a pivot member rotatable relative the body, the pivot member defines a groove to receive the tablet computer, and the chassis connector is located in the groove.

15. The electronic device of claim 14, wherein the keyboard module is located on the body, and an extending direction of the groove is substantially parallel to a plane defined by the keyboard module.

16. The electronic device of claim 10, wherein the chassis connector further comprises a second group of pins, when the tablet computer is in the first position, the second group of pins mates with the second group of slots; and when the tablet computer is in the second position, the second group of pins mates with the first group of slots.

17. The electronic device of claim 16, wherein the first group of pins and the second group of pins have a same definition.

18. The electronic device of claim 10, wherein when the tablet computer is in the first position, the tablet computer is in a first orientation relative to the chassis, when the tablet computer is in the second position, the tablet computer is in a second orientation relative to the chassis, and the first orientation is opposite to the second orientation.
